(19) United States
(12) Patent Application Publication
(10) Pub. No.: US 2019/0104492 A1
(43) Pub. Date: Apr. 4, 2019

(54) Cell Phone-Based Land Navigation Methods and Systems

(71) Applicant: Irvine Sensors Corporation, Costa Mesa, CA (US)

(72) Inventors: David Ludwig, Irvine, CA (US); James W. Justice, Huntington Beach, CA (US)

(73) Assignee: Irvine Sensors Corporation, Costa Mesa, CA (US)

(21) Appl. No.: 15/935,208

(22) Filed: Mar. 26, 2018

Related U.S. Application Data
(60) Provisional application No. 62/477,489, filed on Mar. 28, 2017.

(51) Int. Cl. H04W 64/00; G01C 21/00; G01C 21/08; G01C 21/16; G01C 21/02; G01S 19/49

(52) U.S. Cl. CPC H04W 64/003; G01C 21/005; G01S 19/49; G01C 21/165; G01C 21/025; G01C 21/08

(57) ABSTRACT

An apparatus wherein a smartphone's sensors, i.e.; cameras, compasses and inertial measurements units, and methods for processing the data taken by these sensors, are used to determine accurate and timely geo-locations to enable land navigation in GPS-denied environments. Celestial, terrestrial and inertial land navigation modes are described in terms of how smartphone sensors are exploited and how data from the sensors is processed to achieve accurate and timely geo-position and navigation capabilities in GPS-denied environments.

### CROSS-REFERENCE TO RELATED APPLICATIONS

This application claims the benefit of U.S. Provisional Patent Application 62/477,489, filed Mar. 28, 2017, entitled, “A Cell-phone Based Land Navigation System”, pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

### 1. Field of the Invention

The invention relates generally to the field of land navigation without the use of GPS such as in a GPS-denied environment.

More specifically, the invention relates to a method for using sensor systems commonly found in a conventional smartphone to locate a position on the earth. Exemplar smartphone sensor systems may comprise a smartphone camera, accelerometer, gyroscope, compass, inertial measurement unit (“IMU”) and real-time clock, or a combination of such sensor systems, which sensor systems do not rely on Wi-Fi, GPS, or GSM signals.

### 2. Brief Description of the Prior Art

FIG. 1 depicts a set of pins that have been rendered in an exemplar smartphone display that were generated from a signal received from the GPS constellation of satellites in a prior art GPS-based navigation application. The pins mark a navigator's position on earth to an accuracy of within about 2-10 meters. Even without cell phone coverage, a preload of maps in an area a user expects to cover can display such pins with about a 2-10 meter accuracy.

However, the GPS signal may be denied under certain environmental or military circumstances so that such geolocation is not possible. There is little commercial motivation to address this contingency since GPS and GLOSNASS are readily available to consumers and in the future, the European GLAS system will likely also be available. Relatedly, the accuracy of GPS is generally very good such that older and less accurate navigation techniques that do not rely on GPS signals are rapidly becoming a lost art, e.g., celestial navigation using a sextant, chronometer and a nautical almanac.

Prior art means of navigation without the use of GPS include triangulation using a map and compass and forward tracking from a known point using a highly accurate inertial measurement unit (IMU) to generate velocity and acceleration measurements each of which has its own drawbacks.

What is needed is an apparatus and method of determining geolocation on land with sufficient accuracy and sufficient timeliness to enable land navigation when GPS signals are not available or are denied.

### BRIEF SUMMARY OF THE INVENTION

The invention utilizes existing smartphone sensors (the apparatus) to enable accurate position determination and land navigation in a GPS-denied environment using measurements of angles between terrestrial and celestial objects (the method).

Three preferred geolocation methods of the invention using a conventional smartphone are disclosed and variants and combinations of each are contemplated as falling within the scope of the claims herein. Each method may be used independently or in combination to improve geo-location and navigation and includes: 1) celestial navigation, 2) terrestrial triangulation, and, 3) inertial navigation.

The most accurate sensors in a smartphone are generally the camera (with an angular resolution of approximately 1.2 are minutes) and the real-time clock (with drift typically of less than 10 seconds/day without GPS update). These sensors are used as the primary sensors in a preferred method of the invention. Lower accuracy sensors in a smartphone include the inertial measurement unit and compass which may be used in alternative embodiments of the method of the invention. A novel aspect of the method is the use of the smartphone camera to accurately compute angles for geo-location. In this manner, the smartphone is configured to be used as a sextant without requiring sextant operation skills or a visible local horizon. The method can also be used to provide landmark triangulation navigation by accurately computing angles from an observing site or position.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts an exemplar display output in a prior art smartphone navigation application relying on GPS. The range flags identify the user's smartphone photo capture location with reasonable accuracy. Likewise, the displayed pins provide a detailed terrestrial path history of the user wherein a unique icon is used to pinpoint the user's current location.

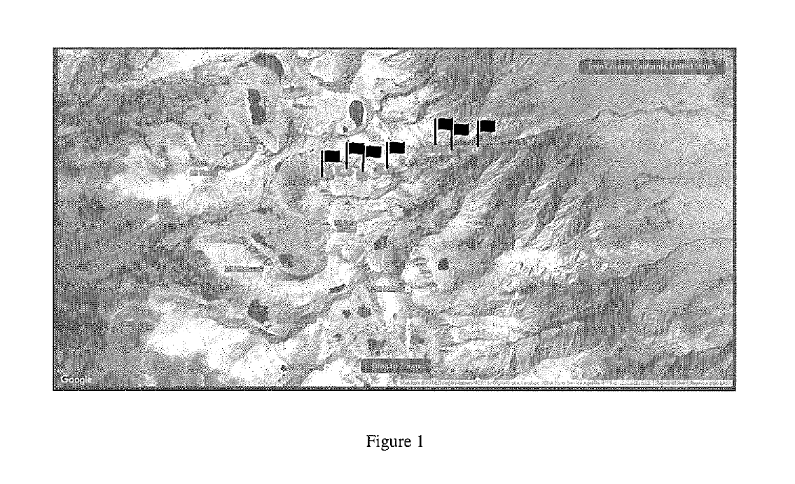

FIG. 2 depicts an artificial horizon of the invention that can be any self-leveling body of liquid such as water wherein the angle of the celestial object to the horizon is twice the angle between the object and its reflection in the body of water.

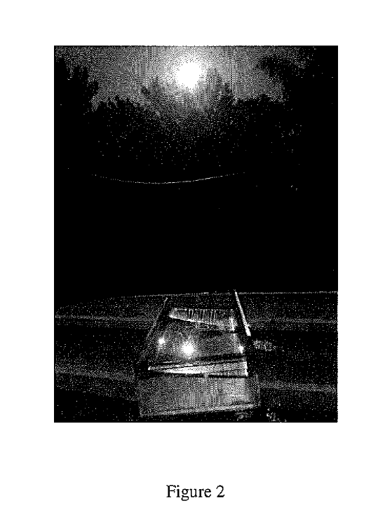

FIG. 3 depicts a method for calculating a user's actual position using a method of the invention. Inputs comprise calculating the number of pixels between an observed celestial object and its reflection and the date and time corrected to UTC time. Nautical almanac tables, such as are used in prior art celestial navigation techniques, are stored in smartphone memory and are retrieved from a smartphone look up table. Smartphone processing performs appropriate arithmetic and geometric calculations to determine the user's position.

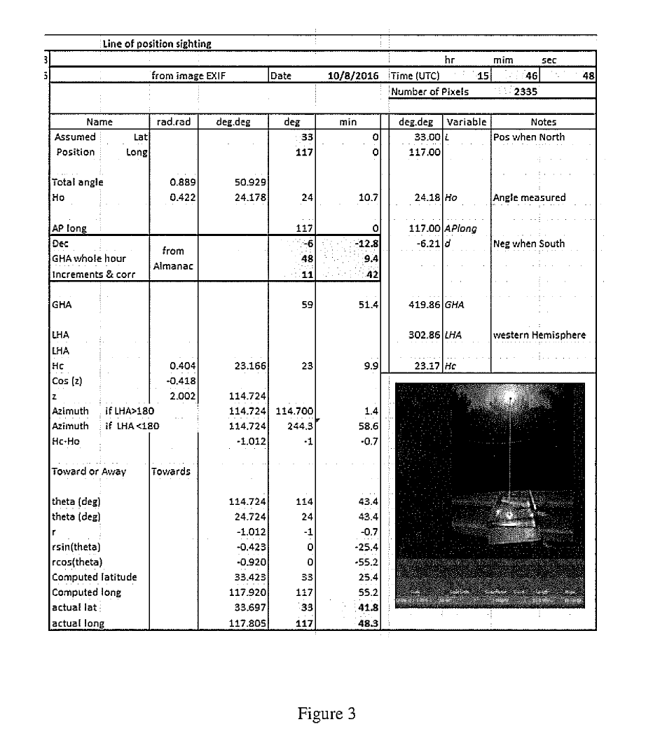

FIG. 4 depicts a panorama image capturing the sun and its reflection off of a self-leveling body of water to determine a noon sight. The noon sight directly yields the user's latitude without the need for correction for estimated position.

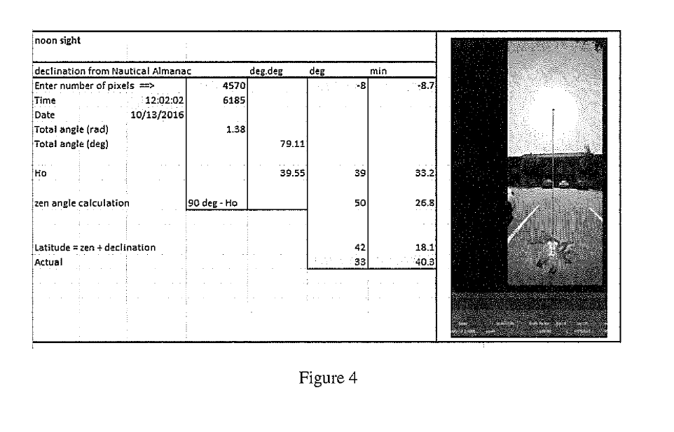

FIG. 5 depicts a smartphone camera image of the Orion constellation (taken early morning Autumn 2016) and Sirius (taken early evening Autumn 2016).

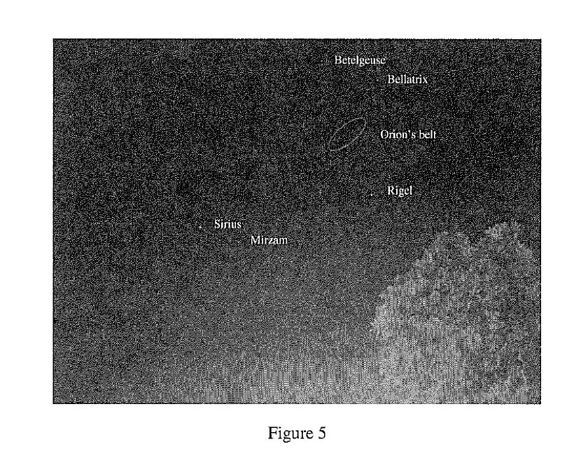

FIG. 6 depicts using augmented reality to improve pointing a camera to a landmark as compared to a traditional compass.

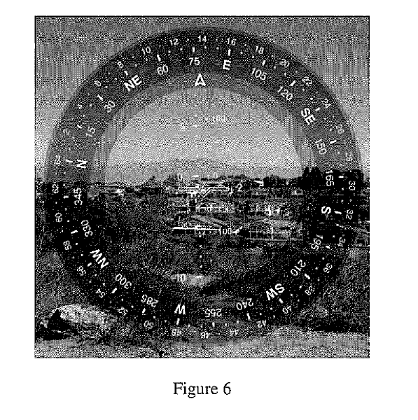

FIG. 7 depicts an example of an angle that is measured between two landmarks (in this example, Santiago Peak and Tustin Blimp Hangars, both located in Orange County, Calif., using the Google Earth draw tool and angle measurement tool (taken from a location at Chaparral Park in Orange County, Calif. (77.8 degrees based on headings).

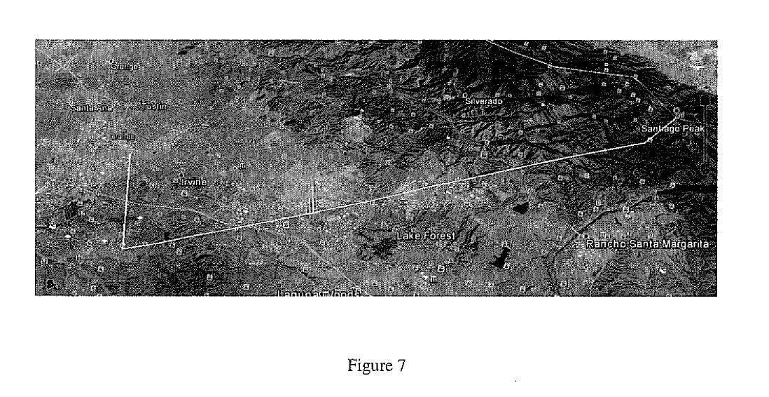

FIG. 8 depicts using a smartphone to directly measure the angle between landmarks by counting the pixels in a panorama image taken from the location of FIG. 7 as measured in the Google Earth image (panorama of landmark-to-landmark angle determination (3779 pixels represents about 77.8 degrees with 0.0206 degree/pixel; pixel IFOV is calculated from the published lens focal length and pixel size is 0.02071 degree/pixel).

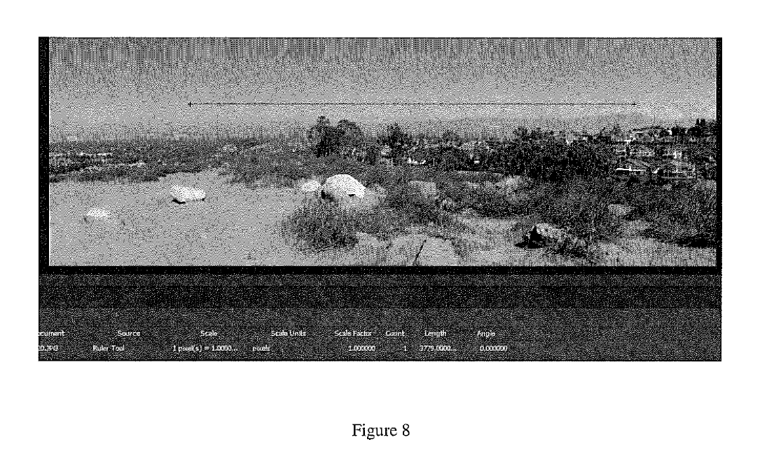

FIG. 9 depicts a magnetic compass drift in two smartphones illustrating increasing temperature errors over time. In the figure, the subject phones were pointed toward magnetic North in the shade test and six degrees off of magnetic North in the sun exposure test).

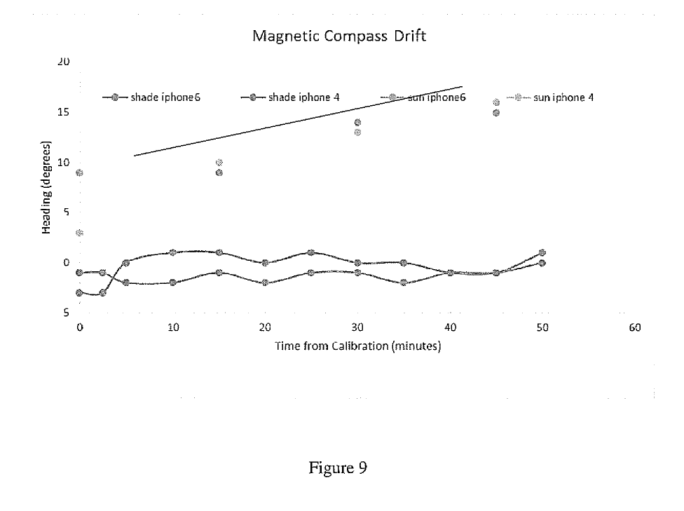

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

The historical method for conventional celestial navigation has generally been comprised of the steps of:

a) estimating the user's position;

b) measuring the angle between a celestial body of interest and a horizon;

c) recording the exact time of measurement;

d) determining the error between the angle measurement and what the angle should be for the assumed position and time;

e) correcting the assumed position using the error computation.

Acceptable results using best practices in maritime navigation are considered to be results that are within one (1) nautical mile of the user's actual location, however errors may greater (but without major consequences) at sea due to the difficulty in obtaining reasonably accurate angle measurements.

In the celestial navigation method of the invention, the most accurate angle measurement to a celestial body using a smartphone is obtained using the phone's camera.

A local horizon is not always useable on land so an artificial horizon may be used in this method of the invention. The artificial horizon may either be a sensor-determined artificial horizon (using an IMU) or a physical artificial horizon.

Any small container of liquid such as water or any self-leveling body of water can serve as an artificial horizon in the method. Measuring the angle between the celestial object and its reflection in the water is equal to twice the desired angle (i.e., from the horizon to the celestial body). No corrections for the height of the user's eye or sextant zero bias are required by the method.

Two different methods for measuring the angle for the celestial navigation method of the invention using a smartphone include:

1) Artificial Horizon—a) Count the pixels in a captured image between the points of measurement (e.g., the celestial body and the horizon), and, b) use the instantaneous field of view (IFOV) of the pixels to determine the total angle measurement. This method works without the need for IMU input but only over shallow angles that fit within a smartphone camera Total Field of View (TFOV), i.e.; a celestial body approximately 30 degrees above the horizon, i.e.; with a total angle of approximately 60 degrees.

2) Panorama+IMU—a) Record a panorama image that includes the artificial horizon and the user-selected celestial object, and, b) determine the angle by measuring the total IFOVs which, in this method, can be greater than the smartphone's TFOV.

Note that certain panorama-stitching software is based on pixel content and not on IMU input. When the pixels in a panorama image are very similar, such as panning a cloudless sky, existing smartphone software may fail to yield a reasonably accurate angular measurement. An IMU-based panorama stitching application or program is preferred for accurate use of a camera's panorama feature using this method.

Taking a “star sight” (i.e., an observation of the altitude of a star made for navigational purposes) using an artificial horizon is difficult due to low lighting conditions but is becoming more practical with the advent of improved low light performance of smartphone cameras. Also, star sights are difficult even at sea using a sextant and are generally limited to just before sunrise and just after sunset, in that the horizon must be visible at the same time the stars are visible to the user. Note that camera and lens modifications may be performed to enhance the capture of lower-light star image reflections in an artificial horizon.

The celestial navigation method using smartphone sensor systems preferably comprises the following steps to improve accurate and timely geo-location and navigation results:
1) Remove or correct geometric distortion of the smartphone camera lens;
2) Perform a centroid estimation to find the center of the celestial object or sun image;
3) Use of a camera application with exposure compensation that is preferably greater than −3 EV in order to render the sun image as a disk instead of a circular image flare;
4) Use of a panorama algorithm, with a large −EV compensation, that uses the smartphone IMU angle for stitching information instead of image content;
5) Provide an accurate photo timestamp with the actual time preferably using the smartphone real-time clock;
6) Perform geolocation computations using nautical almanac sight reduction tables, i.e., the location of the selected celestial objects' Greenwich hour angle and declination;
7) Perform automatic computation of the centroid of celestial object-to-horizon calculation based on the number of pixel IFOVs in the smartphone image;
8) Input the calculated angle and time from the smartphone sensor system real-time clock into the sight reduction tables;
9) Return of the calculated position of the user.

It is noted the celestial navigation method's accuracy may degrade over a day without GPS updates (due to smartphone real-time clock drift).

The terrestrial navigation method of the invention is enabled using accurate measurements of the angles between at least two terrestrial landmarks. Terrestrial navigation has traditionally relied on high quality unambiguous landmarks along with map and compass triangulation for position determination. Errors in compass readings often limited ultimate position determination.

Using the terrestrial navigation method of the invention, pointing errors are minimized using an azimuth circle as an augmented reality overlay in the smartphone camera image. However, inaccurate compass calibration may still exist. Magnetic compass deviation errors can be ignored using the above triangulation technique because the only important angle in the method is the angle that is calculated between the respective landmarks.

Compass drift and deviation errors do not contribute significantly to the measurement of an angle difference between the landmarks. Further improvement in accuracy may be obtained using the smartphone camera in panorama mode and calculating the number of pixel IFOVs to determine the angle difference between the landmarks.

The terrestrial navigation method of the invention using the smartphone sensors preferably comprises the following steps to enable accurate and timely geo-location and navigation results.
1) Pre-loading of maps of expected area of travel; pre-loading of locations of major landmarks on maps into smartphone memory;
2) Removing geometric distortion of smartphone camera lens;
3) Identification in an imaged panorama photo of potential landmarks expected to be used;
4) Calculation of the angle between landmarks in the panorama photo that have been identified;
5) Pattern recognition of angles between landmarks on the map and angles calculated from the panorama;
6) Alignment of angles measured and pre-loaded coordinates resulting in an estimate of a location and placement of a pin on a downloaded map.

A smartphone has all sensor elements needed for a third method of the invention, i.e., the inertial navigation method. Sensor elements needed for the inertial navigation method may comprise a three-degrees of freedom (3 DOF) compass and a six-degrees of freedom (6 DOF) IMU (comprised of, e.g., three gyroscopes and three accelerometers) as are commonly found in prior art smartphones.

A smartphone's sensor quality is generally dictated by minimizing production cost vs. achieving high accuracy. Drift in smartphone compass readings without a calibration in, e.g., a 45 minute period, has shown a drift of + or −1 degree while the devices were in the shade. More so, in direct sun, compass drift has been observed in the range +10 degrees due to heating effects. Fortunately, magnetic compass drift in a smartphone is easily recalibrated.

Drift in a 6 DOF IMU is a more significant problem. Such IMU drift can be significant including when using Kalman filtering. With terms for position, velocity, acceleration and the last computed position, these errors can mount quickly. Inertial navigation is most effectively used for short term navigation from a known, high confidence starting position.

The inertial navigation method using smartphone sensor systems may use the following method to achieve accurate and timely geo-location and navigation results:

1) Regular recalibration of the smartphone magnetic compass drift;

2) Use of MU data to determine position, velocity, acceleration, and starting position using a Kalman filter estimation routine;

3) Recalibration using new starting position data when or as accurate position information becomes available.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

What is claimed:

1. A method for determining accurate geo-location and navigation in GPS denied environments utilizing existing smart phone sensors to enable position determination and land navigation accuracy using the sensors in a smart phone and observing angles between celestial objects and terrestrial objects and a horizon reference.

2. The sensors of claim 1 may be cameras.

3. The sensors of claim 1 may be 3 DOF compasses.

4. The sensors of claim 1 may be 6 DOF inertial measurement units (IMUs)

5. The geo-location and navigation methods of claim 1 may include a celestial navigation mode.

6. The geo-location and navigation methods of claim 1 may include a terrestrial navigation mode.

7. The geo-location and navigation methods of claim 1 may include an inertial navigation mode.

8. The celestial navigation mode of claim 5 may include accurate measurements of the angles between celestial objects and a local horizon determined by direct horizon viewing or by reference to the surface of a container of water.

9. The terrestrial navigation mode of claim 6 may include accurate measurements of the angles between terrestrial objects of known locations.

10. The internal navigation mode of claim 7 may include use of a 3 DOF magnetic compass that is recalibrated by use of a series of known starting positions as they become available.

11. The inertial navigation Mode of claim 7 may include the use of a 6 DOF IMU whose outputs are processed by a Kalman filter to determine position, velocity, and acceleration.
